(19) United States
(12) Patent Application Publication
(10) Pub. No.: US 2007/0253992 A1
(43) Pub. Date: Nov. 1, 2007

(54) POISON BAIT

(75) Inventors: Shun-ichi KUBOTA, Toyonaka-shi (JP); Kazuhide Nakada, Takarazuka-shi (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED, Tokyo (JP)

(21) Appl. No.: 11/696,783

(22) Filed: Apr. 5, 2007

(30) Foreign Application Priority Data
Apr. 26, 2006 (JP) 2006-121668

(51) Int. Cl. A01N 25/08; A01N 47/28

(52) U.S. Cl. 424/410; 514/594

(57) ABSTRACT

A poison bait in the form of gel which comprises an active ingredient for controlling wood harmful insect, water and cellulose ether has an excellent efficacy for controlling wood harmful insects, wherein the content ratio of water:the cellulose ether is 4:1 to 3:4.

### TECHNICAL FIELD

The present invention relates to a poison bait for controlling wood harmful insect, a method for controlling wood harmful insect, a bait for wood harmful insect and a method for confirming the presence of wood harmful insect.

### BACKGROUND ART

It is said that economical damage by wood harmful insects injuring wood materials of constructions such as houses and the like such as cultural property constructions and the like, particularly, by termite, reaches ten-billion dollars or more in U.S. and several billion dollars in Japan. There are up to now various compounds and controlling methods suggested intending to control wood harmful insects. For example, poison baits using delayed effective termite controlling ingredients have been investigated from old times as one method for exterminating the whole colony of termite. As a practical matter, there is mentioned a poison bait for termite, as a termite controlling ingredient, a benzoylphenylurea compound that is a chitin synthesis inhibitor. (cf. JP2004-217646A) This poison bait for termite is applied by a method in which a termite controlling ingredient is allowed to be contained in paper, wood or the like which is then inserted into a station buried in the ground, or it is set directly at positions harmed by termite or placed in a given vessel before setting. Such application methods have not necessarily been fully satisfactory since it is necessary to select the setting position, and termite has a nature of willingly eat a substance retaining appropriate moisture, then, it is necessary to spray water frequently to keep moisture of a poison bait.

### DISCLOSURE OF THE INVENTION

The present invention provides a poison bait manifesting an excellent controlling effect on wood harmful insects, especially termite. Further, the present invention also provides a bait on which wood harmful insects show an excellent eating nature.

The poison bait comprises an active ingredient for controlling wood harmful insect, water and cellulose ether, wherein the content ratio of water:the cellulose ether is 4:1 to 3:4. The poison bait can be used for controlling wood harmful insect by setting it in an effective amount at the habitat of wood harmful insects or the invasion place of the wood harmful insects.

Further, the bait of the present invention comprises water and a cellulose ether, wherein the content ratio of water:the cellulose ether is 4:1 to 3:4. The bait can be used for confirming the presence of wood harmful insect by setting it at the habitat of wood harmful insects or the invasion place of the wood harmful insects.

Examples of the active ingredient for controlling wood harmful insect include organophosphorus compounds such as fenitrothion, fenthion, diazinon, chlorpyrifos, DDVP, cyanophos, dimethoate, phenthoate, malathion and azinphos-methyl; carbamate compounds such as BPMC, benfuracarb, propoxur and carbaryl; pyrethroid compounds such as etofenprox, fenvalerate, esfenvalerate, fenpropathrin, cypermethrin, permethrin, cyhalothrin, deltamethrin, cycloprothrin, fluvalinate, biphenthrin, tralomethrin, silafluofen, d-phenothrin, cyphenothrin, d-resmethrin, acrinathrin, cyfluthrin, tefluthrin, transfluthrin, tetramethrin, allethrin, prallethrin, empenthrin, imiprothrin, d-furamethrin and 2,3,5,6-tetrafluoro-4-(methoxymethyl)benzyl (EZ)-(1RS, 3RS; 1RS, 3SR)-2,2-dimethyl-3-prop-1-enylcyclopropanecarboxylate; N-cyanoamidine compounds such as N-cyano-N′-methyl-N′-(6-chloro-3-pyridylmethyl) acetamidine; neonicotinoid compounds such as clothianidin, imidacloprid, nitenpyram, thiacloprid, thiamethoxam and dinotefuran; chlorinated hydrocarbon compounds such as endosulfan and γ-BHC; insect growth regulating compounds such as benzoylphenylurea compounds (e.g., bistrifluron, hexaflumuron, diflubenzuron, lufenuron, noviflumuron, novaluron, chlorfluazuron, teflubenzuron and flufenoxuron), thiadiazin compounds (e.g., buprofezin), juvenile hormone-like compounds (e.g., pyriproxyfen, fenoxycarb, methoprene and hydroprene), oxazoline compounds (e.g., etoxazole), triazine compounds (e.g., cyromazine) and bisacylhydrazine compounds (e.g., halofenozide and methoxyfenozide); thiourea compounds such as diafenthiuron; phenylpyrazole compounds such as fipronil and ethiprole; hydramethylnon; sulfluramide; chlorfenapyr, metoxadiazone; pyridaryl; bromopropylate; tetradifon; quinomethionate; pyridaben; fenpyroximate; tebufenpyrad; polynactin complex (tetranactin, dinactin, trinactin); pyrimidifen; milbemectin; avermectin; ivermectin; and azadirachtin (AZAD).

In the present invention, preferable active ingredient for controlling wood harmful insect are delayed effective ingredients, for example, benzoylphenylurea compounds such as bistrifluron, hexaflumuron, diflubenzuron, lufenuron, noviflumuron, novaluron, chlorfluazuron, teflubenzuron and flufenoxuron, fipronil and hydramethylnon. More preferable are the above-mentioned benzoylphenylurea compounds.

The content of the active ingredient for controlling wood harmful insect is generally 0.01 to 10 wt % in the poison bait of the present invention. The active ingredient can be mixed in the poison bait as it is or as a formulation. The formulation can be flowable, microcapsule formulation, oil solution, emulsifiable concentrate and so on.

The cellulose ether used for the present invention is a substance in which one or more hydroxyl groups of cellulose are etherized. In the cellulose ether, cellulose is typically alkylated by at least one selected from the group consisting of alkyl groups (e.g., methyl, ethyl, propyl, butyl), hydroxyalkyl groups (e.g., hydroxyethyl, hydroxypropyl) or carboxyalkyl groups (e.g., carboxymethyl). When cellulose is alkylated by carboxyalkyl group, the cellulose ether may be a salt such as alkali metal salt. Examples of the cellulose ether include methylcellulose, ethylcellulose, hydroxyethylcellulose, hydroxypropylcellulose, ethylhydroxyethylcellulose, hydroxypropylmethylcellulose, carboxymethylcellulose, carboxymethylethylcellulose and sodium carboxymethylcellulose. Preferable examples of the cellulose ether include methylcellulose, hydroxypropylcellulose, hydroxypropylmethylcellulose, carboxymethylcellulose and sodium carboxymethylcellulose.

The poison bait of the present invention can be produced by a method in which an active ingredient for controlling wood harmful insect is diluted in a suitable solvent or formulated if necessary before mixing with water, then, a cellulose ether is mixed, and the mixture is gelled by heating and cooling according to demands. When, the active ingredient and the cellulose ether are both in the form of solid (powder, particle and the like), the poison bait can be produced by a method in which water and a mixture prepared by previously mixing them are mixed, and the mixture is gelled by heating and cooling according to demands.

The content ratio of water to the cellulose ether in the poison bait of the present invention is usually in a range of 4:1 to 3:4, suitably 4:1 to 1:1 by weight (water:cellulose ether), and the total content of water and the cellulose ether is usually in a range of 70 to 99.9 wt %, suitably 80 to 99.9 wt %. In such a case, the contents of water and the cellulose ether are not particularly restricted, and suitably, the content of water is in a range of 40 to 70 wt % and the content of the cellulose ether is in a range of 25 to 55 wt %.

The poison bait of the present invention can further contain a synergist in addition to the active ingredient for controlling wood harmful insect, water and the cellulose ether. Examples of the synergist include bis(2,2,3,3-tetrachloropropyl)ether (S-421), N-(2-ethylhexyl)bicycle [2.2.1]hept-5-en-2,3-dicarbodiimide (MGK-264) and α-[2-(2-butoxyethoxy)ethoxy]-4,5-methylenedioxy-2-propyltoluene (piperonyl butoxide).

The bait of the present invention can be produced by mixing the cellulose ether with water and gelled by heating and cooling according to demands.

The content ratio of water to the cellulose ether in the bait of the present invention is usually in a range of 4:1 to 3:4, suitably 4:1 to 1:1 by weight (water:cellulose ether), and the total content of water and the cellulose ether is usually in a range of 70 to 100 wt %, suitably 80 to 100 wt %. In such a case, the contents of water and the cellulose ether are not particularly restricted, and suitably, the content of water is in a range of 45 to 70 wt % and the content of the cellulose ether is in a range of 25 to 55 wt %.

The poison bait and the bait of the present invention can further contain preservative, UV stabilizer, antioxidant, dyestuff, coloring agent and the like. Examples of the preservative include benzoic acid, sodium benzoate, propyl p-hydroxybenzoate, butyl p-hydroxybenzoate, o-phenylphenol, sodium salt of o-phenylphenol, dehydroacetic acid, sodium dehydroacetate, thiobendazole and 3-iodo-2-propargyl butylcarbamate (IPBC). Examples of the antioxidant include dibutylhydroxytoluene (BHT), butylhydroxyphenol (BHA), erythorbic acid, ascorbic acid, tocopherol and stanous chloride. Examples of the dyestuff and coloring agent include inorganic pigment such as iron oxide, titanium oxide and Prussian blue, organic dyestuff such as alizarin dyestuff, azo dyestuff, metal phthalocyanine dyestuff and their salts (e.g., iron salt, manganese salt, boron salt, copper salt, cobalt salt, molybdenum salt, zinc salt).

Furthermore, the poison bait and the bait of the present invention can contain the other material containing cellulose in addition to the cellulose ether. Examples of the material containing cellulose include wood materials such as wood chip and sawdust and various cellulose products. Examples of the trees for the wood material include coniferous trees such as Pinus densiflora, Pinus thunbergii and Tsuga sieholdii and broad-leaved trees such as Betula alleghaniensis and Carya illinoensis. Examples of the cellulose product include cellulose-containing paper (e.g., cellulose paper, paper containing starch, inorganic fiber paper) as well as cellulose powder, crystalline cellulose and fibrous cellulose

The wood harmful insects controlled by the poison bait of the present invention and the wood harmful insects which eat the bait of the present invention are typically termite. Termite is an Isoptera insect and exemplified by the followings:

Mastotermitidae, Termopsidae (e.g., Zootermopsis spp., Archotermopsis spp., Hodotermopsis spp., Porotermes spp., Stolotermes spp.), Kalotermitidae (e.g., Kalotermes spp., Neotermes spp., Cryptotermes spp., Incistermes spp., Glyptotermes spp.), Hodotermitidae (e.g., Hodotermes spp., Microhodotermes spp., Anacanthotermes spp.), Rhinotermitidae (e.g., Reticulitermes spp., Heterotermes spp., Coptotermes spp., Schedolinotermes spp.), Serritermitidae, Termitidae (e.g., Amitermes spp., Drepanotermes spp., Hopitalitermes spp., Trinervitermes spp., Macrotermes spp., Odontotermes spp., Microtermes spp., Nasutitermes spp., Pericapritermes spp., Anoplotermes spp.).

Typical examples of the termite include Reticulitermes speratus, Coptotermes formosanus, Incisitermes minor, Cryptotermes domesticus, Odontotermes formosanus, Neotermes koshunensis, Glyptotermes satsumensis, Glyptotermes nakajimai, Glyptotermes fuscus, Glyptotermes kodamai, Glyptotermes kushimensis, Hodotermopsis japonica, Coptotermes guangzhoensis, Reticulitermes miyatakei, Reticulitermes flaviceps amamianus, Reticulitermes kanmonesis, Nasutitermes takasagoensis, Pericapritermes nitobei, Sinocapritermes mushae, Reticulitermes flavipes, Reticulitermes hesperus, Reticulitermes virginicus, Reticulitermes tibialis, Heterotermes aureus and Zootermopsis nevadensis.

Examples of the wood harmful insects other than termite include Coleoptera insects Lyctidae, Bostrychidae, Anobiidae and Cerambycidae.

The method of the present invention for controlling wood harmful insect is performed usually by applying the poison bait of the present invention as it is at a site harmed by wood harmful insects, or by a conventional poison bait application method, that is, by a method in which the poison bait of the present invention is placed in a vessel or the like, and the vessel is set at a place of inhabitation of wood harmful insects or a place of prediction of invasion of wood harmful insects. Specifically, when the wood harmful insect is termite for example, mentioned are methods in which the poison bait is set at a portion harmed by termite or a termite passage way, alternatively the poison bait is set under the floor of general houses and the like or on circumjacent soil. The application amount of such a poison bait of the present invention can be appropriately set depending on the kind of target wood harmful insects, generation conditions, places and the like, and usually, the poison bait is applied in an amount of about 10 to 200 g per place, and under the floor of general houses and the like or on circumjacent soil, applied at 1 to 10 positions per 3 m².

The method of the present invention for confirming the presence of wood harmful insect is performed by a method in which usually the bait of the present invention is set as it is or placed in a vessel or the like before setting at a position of prediction of inhabitation or invasion of wood harmful insects. Specifically, the bait for wood harmful insect of the present invention is placed at a position of prediction of inhabitation or invasion of wood harmful insects under the floor of general houses or on circumjacent soil and the like and left for a given period, then, it can be confirmed that the placed position is a habitat or invasion place of wood harmful insects, by a trace of eating by wood harmful insects of the bait of the present invention placed or, when the wood harmful insect is termite, by the presence of circumjacent termite passage way, alternatively, when these are not present, it can be confirmed that the placed position is not a habitant or invasion place of wood harmful insects, by visual means and the like. Thereafter, wood harmful insects can be efficiently controlled by placing the poison bait of the present invention or another poison bait for controlling wood harmful insect at the position of confirmation of eating by wood harmful insects and confirmation of inhabitation or invasion by wood harmful insects.

The application amount of such a bait of the present invention can be appropriately set depending on the kind of target wood harmful insects, generation conditions, places and the like, and usually, the bait is applied in an amount of about 10 to 200 g per place, and under the floor of general houses and the like or on circumjacent soil, applied at 1 to 10 positions per 3 m².

### EXAMPLES

The present invention will be illustrated more specifically by production examples, test examples and the like, but the present invention is not limited only to these examples.

### Production Example 1

One-fifth (0.2) part by weight of N-2,6-difluorobenzoyl-N′-2-fluoro-4-trifluoromethylphenylurea

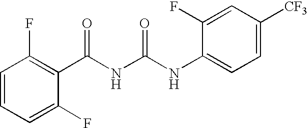

as active ingredient and 40 parts by weight of methylcellulose were mixed, then, 59.8 parts by weight of distilled water was added to this and the mixture was stirred at room temperature, to obtain a poison bait in the form of gel (hereinafter, referred to as poison bait 1 of the present invention).

### Production Example 2

The same operation as in Production Example 1 was conducted using sodium carboxymethylcellulose instead of methylcellulose, to obtain a poison bait in the form of gel (hereinafter, referred to as poison bait 2 of the present invention).

### Reference Example 1

One-fifth (0.2) part by weight of N-2,6-difluorobenzoyl-N′-2-fluoro-4-trifluoromethylphenylurea as active ingredient and 40 parts by weight of gellangum (trade name: KELCOGEL, provided by Dainippon Sumitomo Pharma Co., Ltd.) were mixed, then, 59.8 parts by weight of distilled water was added to this and the mixture was stirred, to obtain a poison bait in the form of gel (hereinafter, referred to as comparative poison bait 1).

### Test Example 1

Into a plastic Petri dish of 9 cm diameter, 4% agarose was poured to give a thickness of about 5 mm, and allowed to stand still at room temperature to cause solidification. On the solidified agarose, a circular pore of 35 mm diameter (hereinafter, referred to as well) was bored. The poison bait 1 of the present invention was fully packed into a plastic vessel of 35 mm outer diameter (about 33 mm inner diameter), then, the vessel was placed into the well so that the opening faced upward. Thereafter, 20 ergates of Coptotermes formosanus were released in the above-mentioned Petri dish which was then capped and sealed with parafilm. After storing for 2 weeks in dark place, the dish was opened, and conditions of Coptotermes formosanus in the Petri dish (life and death, and existence or non-existence of conditions such as agony and the like of living insects) were observed and the controlling ratio was calculated. The same test was repeated four times and the average was calculated. The same operations were performed using the poison bait 2 of the present invention and the comparative poison bait 1, respectively, instead of the poison bait 1 of the present invention, and respective controlling ratios were calculated.

As control, non-treated filter paper (33 mm diameter) was placed into the well, and the same operation was performed. The results are shown in Table 1.

TABLE 1

| | Controlling ratio | | |
|---|---|---|---|
| | Mortality | Positive | Total |
| | (%) | condition (%) | (%) |
| Poison bait 1 of the | 24 | 38 | 62 |
| present invention | | | |
| Poison bait 2 of the | 33 | 38 | 71 |
| present invention | | | |
| Comparative poison | 1 | 0 | 1 |
| bait 1 | | | |
| Filter paper | 0 | 0 | 0 |
| (non-treated) | | | |

### Test Example 2

Distilled water and sodium carboxymethylcellulose (CMC-Na) were added to give a given content ratio and stirred, to obtain a mixture of them.

Into a plastic Petri dish of 9 cm diameter, 4% agarose was poured to give a thickness of about 5 mm, and allowed to stand still at room temperature to cause solidification. On the solidified agarose, a circular pore of 35 mm diameter (hereinafter, referred to as well) was bored. The above-mentioned mixture was fully packed into a plastic vessel of 35 mm outer diameter (about 33 mm inner diameter), then, the vessel was placed into the well so that the opening faced upward. Thereafter, 20 ergates of Coptotermes formosanus were released in the above-mentioned Petri dish which was then capped and sealed with parafilm. After storing for 1 week in dark place, the eating nature was judged from the decrease amount and states of the mixture in the Petri dish. The results are shown in Table 2.

TABLE 2

| Content ratio (weight | | |
|---|---|---|
| ratio, water:CMC-Na) | Gelling condition | Eating nature |
| 19:1 | X | — |
| 9:1 | X | — |
| 5:1 | Δ | — |
| 3.3:1 | ◯ | ◯ |
| 1:1 | ◯ | ◯ |
| 2:3 | X | X |
| 1:4 | X | X |
| 1:19 | X | X |

[Gelling condition]
◯: Completely dissolved, and gelled. Little flowability
Δ: Completely dissolved, however, not gelled and flowability is somewhat significant.
X: Incompletely dissolved, and solidified. Or, completely dissolved, however not gelled and is very significant.
[Eating nature]
◯: Good
X: No good
—: States are bad, and eating nature cannot be observed.

We claim:

1. A poison bait which comprises an active ingredient for controlling wood harmful insect, water and cellulose ether, wherein the content ratio of water:the cellulose derivative is 4:1 to 3:4.

2. The poison bait according to claim 1, wherein the content of the active ingredient is 0.01 to 10 wt % and the total content of water and the cellulose ether is 70 to 99.9 wt %.

3. The poison bait according to claim 1, wherein the cellulose ether is carboxymethylcellulose or sodium carboxymethylcellulose.

4. The poison bait according to claim 1, wherein the cellulose ether is methylcellulose.

5. The poison bait according to any one of claims 1 to 4, wherein the active ingredient for controlling wood harmful insect is a benzoylphenylurea compound.

6. A method for controlling a wood harmful insect which comprises setting an effective amount of the poison bait described in claim 1 at the habitat of wood harmful insects or the invasion place of the wood harmful insects.

7. The method according to claim 6, wherein the wood harmful insect is termite.

8. A bait in the form of gel which comprises water and a cellulose ether, wherein the content ratio of water:the cellulose ether is 4:1 to 3:4.

9. The bait according to claim 8, wherein the total content of water and the cellulose ether is 70 to 100 wt %.

10. The bait according to claim 8 or 9, wherein the cellulose ether is carboxymethylcellulose or sodium carboxymethylcellulose.

11. A method for confirming the presence of wood harmful insect which comprises setting the bait described in claims 8 at the habitat of wood harmful insects or the invasion place of the wood harmful insects.

12. The method according to claim 11, wherein the wood harmful insect is termite.
